(19) United States
(12) Patent Application Publication
(10) Pub. No.: US 2020/0334516 A1
(43) Pub. Date: Oct. 22, 2020

(54) COMPUTER AND DATA PROCESSING METHOD

(71) Applicant: HITACHI, LTD., Tokyo (JP)

(72) Inventors: Mitsuharu TAI, Tokyo (JP); Jun FURUYA, Tokyo (JP); Nobuhiro FUKUDA, Tokyo (JP); Tadashi OKUMURA, Tokyo (JP); Masahiko ANDO, Tokyo (JP)

(73) Assignee: HITACHI, LTD., Tokyo (JP)

(21) Appl. No.: 16/817,801

(22) Filed: Mar. 13, 2020

(30) Foreign Application Priority Data
Apr. 19, 2019 (JP) 2019-080141

(51) Int. Cl. G06N 3/04; G06N 3/08

(52) U.S. Cl. CPC G06N 3/0445; G06N 3/08

(57) ABSTRACT

A computer generates a model for outputting an output value on the basis of a plurality of pieces of time-series data having different data types. The model includes a network that is for hied of connections of nodes having a recursive structure and updates states of the nodes according to a predetermined time step, and an adder that calculates the output value. The computer comprises: a learning unit configured to execute, for each of a plurality of output values, a learning process of calculating weight data including the plurality of weights by using learning data and a first storing unit configured to store a plurality of learning results each of which correlates a type of the output value and the weight data with each other.

### CLAIM OF PRIORITY

The present application claims priority from Japanese patent application JP 2019-80141, filed on Apr. 19, 2019, the content of which is hereby incorporated by reference into this application.

### BACKGROUND

The present invention relates to machine learning.

In recent years, the need for a cross-field information infrastructure has been increasing. For example, in the field of city planning, the construction and dissemination of data-driven city planning methods for contributing to the enhancement of administrative services and the value of regions to support building consensus between stakeholders using Information and Communication Technology (ICT) is attracting attention.

Conventional city planning has often been based on administrative-led experiences and feelings or arbitrary methods. Therefore, in most cases, it is difficult for the residents to accept it, the effect is not clear, and even if it is effective, it depends on the experience or the ability of the planner and cannot be passed on to third parties.

City planning requires a wide variety of data, such as data indicating economic activity, data related to traffic flow and real estate, water usage data, and qualitative data obtained through questionnaires and the like.

Moreover, regarding information obtained by utilizing the above-described data, there are diverse indices indicating the state of areas and the effects of the measures (for example, local tax revenues, the income of tourist sites, the number of visiting persons in buildings and events, a traffic flow itself or a traffic congestion state, logistics, and the like). Particularly, the influence of time is also an important factor in obtaining indices indicating the effects of measures.

### SUMMARY OF THE INVENTION

In data-driven city planning, it is important to accurately grasp the current state of a city and the effects of policies or measures. In order to solve this problem, it is necessary to select a group of an output value which serves as an evaluation index such as a Key Performance Indicator (KPI), specify data that contributes to the output value, and analyze a relationship between pieces of the data or between the output value and the data. The output value may be used as data for calculating another output value. In the following description, data including an output value, used for calculating the output value is referred to as input data.

Each of a plurality of KPIs changes while having a temporal or spatial correlation with a plurality of types of input data.

In recent years, a machine learning method for generating a correlation between input data and an output value deductively as a black box (model) is attracting attention.

For example, in a method of generating a neural network as a model, learning for adjusting the weight between nodes is performed using teacher data composed of a set of input data and an output value. By inputting new input data to the neural network after learning, a desired output value can be obtained.

When one tries to use the machine learning method, it is necessary to prepare appropriate teacher data in advance. However, in data-driven city planning, it cannot be expected that appropriate teacher data is prepared in advance.

For example, when visualizing the activity of areas, it is not possible to set what kind of KPI should be selected and what kind of input data should be prepared to construct a useful model in advance. In general, there is no absolute standard for KPIs for understanding the state of areas. Moreover, data used for city planning has a very large number of data types and number of pieces thereof, and the pieces of data and the data and the KPI often have a complex correlation.

Therefore, in the conventional machine learning method, the calculation cost (calculation time and power consumption) required for generating a model is extremely expensive. Moreover, since the generated model is complex, it is difficult to divert and update the model.

The present invention realizes a technology for generating models each of which can handle a variety of input data and an output value of data-driven city planning without increasing a calculation cost.

A representative example of the present invention disclosed in this specification is as follows: a computer comprises an arithmetic device and a storage device coupled the arithmetic device and generates a model for outputting an output value on the basis of a plurality of pieces of time-series data having different data types. The model includes a network that is formed of connections of a plurality of nodes having a recursive structure and updates states of the plurality of nodes according to a predetermined time step, and an adder that calculates the output value by adding values obtained by multiplying each of a plurality of values output from the network by a plurality of weights. The computer further comprises: a learning unit configured to execute, for each of a plurality of output values, a learning process of calculating weight data deter mining the model and including the plurality of weights by using learning data composed of teacher data and a plurality of pieces of time-series data having different data types; and a first storing unit configured to store a plurality of learning results each of which correlates a type of the output value and the weight data with each other.

According to one embodiment of the present invention, models each of which can handle a wide variety of input data and an output value can be generated without increasing a calculation cost. Other problems, configurations, and effects than those described above will become apparent in the descriptions of embodiments below.

### BRIEF DESCRIPTION OF THE DRAWINGS

The present invention can be appreciated by the description which follows in conjunction with the following figures, wherein:

FIG. 1 is a diagram illustrating a configuration of a computer according to Embodiment 1;

FIG. 2 is a diagram illustrating an example of a data structure of learning data management information of Embodiment 1;

FIG. 3 is a diagram illustrating an example of a data structure of learning result management information of Embodiment 1;

FIG. 4 is a diagram illustrating an example of a functional block of a learning unit of Embodiment 1;

FIG. 5 is a diagram illustrating an example of the structure of a reservoir of Embodiment 1;

FIG. 6 is a flowchart for describing a learning process executed by the learning unit of Embodiment 1;

FIG. 7 is a diagram illustrating an example of specific data processing of the learning process of Embodiment 1;

FIG. 8 is a graph illustrating a difference between the learning process of Embodiment 1 and a conventional learning process;

FIG. 9 is a diagram illustrating an example of a functional block of a predictor of Embodiment 1;

FIG. 10 is a flowchart for describing a prediction process executed by the predictor of Embodiment 1;

FIG. 11 is a diagram illustrating an example of a data structure of the learning result management information of Embodiment 2;

FIG. 12 is a diagram illustrating an example of a functional block of the learning unit of Embodiment 2;

FIG. 13 is a flowchart for describing the learning process executed by the learning unit of Embodiment 2;

FIG. 14 is a diagram illustrating an example of specific data processing of the learning process of Embodiment 2;

FIG. 15 is a diagram illustrating an example of a functional block of the predictor of Embodiment 2;

FIG. 16 is a flowchart for describing the prediction process executed by the predictor of Embodiment 2;

FIG. 17 is a diagram illustrating an example of a functional block of the learning unit of Embodiment 3;

FIG. 18 is a flowchart for describing the learning process executed by the learning unit of Embodiment 3;

FIG. 19 is a diagram illustrating an example of a functional block of the predictor of Embodiment 3; and

FIG. 20 is a flowchart for describing the prediction process executed by the predictor of Embodiment 3.

### DETAILED DESCRIPTION OF THE EMBODIMENT

Now, a description is given of an embodiment of this invention referring to the drawings. It should be noted that this invention is not to be construed by limiting the invention to the content described in the following embodiment. A person skilled in the art would easily recognize that a specific configuration described in the following embodiment may be changed within the scope of the concept and the gist of this invention.

In a configuration of this invention described below, the same or similar components or functions are assigned with the same reference numerals, and a redundant description thereof is omitted here.

Notations of, for example, “first”, “second”, and “third” herein are assigned to distinguish between components, and do not necessarily limit the number or order of those components.

The position, size, shape, range, and others of each component illustrated in, for example, the drawings may not represent the actual position, size, shape, range, and other metrics in order to facilitate understanding of this invention. Thus, this invention is not limited to the position, size, shape, range, and others described in, for example, the drawings.

First, an overview of the present invention will be described.

In the conventional technique, it is necessary to prepare a model such as a neural network for each output value. Therefore, in such city planning that a plurality of output values is obtained, an enormous calculation cost is required for generation of all models. Moreover, when the parameters of a plurality of models are stored, if the number of parameters is large, a large storage capacity is required and the cost increases.

Moreover, in the conventional technique, an enormous calculation cost is required when preparing a model for obtaining a new output value.

Therefore, the present invention executes machine learning using an Echo State Network (ESN) to generate a model for calculating respective output values and store definition information of the model as a learning result.

The ESN is a model composed of an unlayered network (reservoir) and a linear adder and receiving time-series data as an input (for example, see PCT International Publication No. WO2002/031764 and Jaeger H. and Haas H., Harnessing nonlinearity: “Predicting chaotic systems and saving energy in wireless communication”, Science, 304, pp. 78-80, 2004). A weight between nodes in the network of the ESN is fixed, and a weight between the network and the linear adder is a learning target. Therefore, the use of an ESN provides an advantage that the calculation cost required for generating a model can be reduced as compared to an ordinary neural network.

Moreover, a sampling interval of time-series data input to an ESN is a value deter mined from a relation between the time-series data input and an output value and is an important parameter contributing to accuracy of the output value of a model.

The present invention also learns a sampling interval of time-series data used for calculating an output value and stores the same as a learning result.

### Embodiment 1

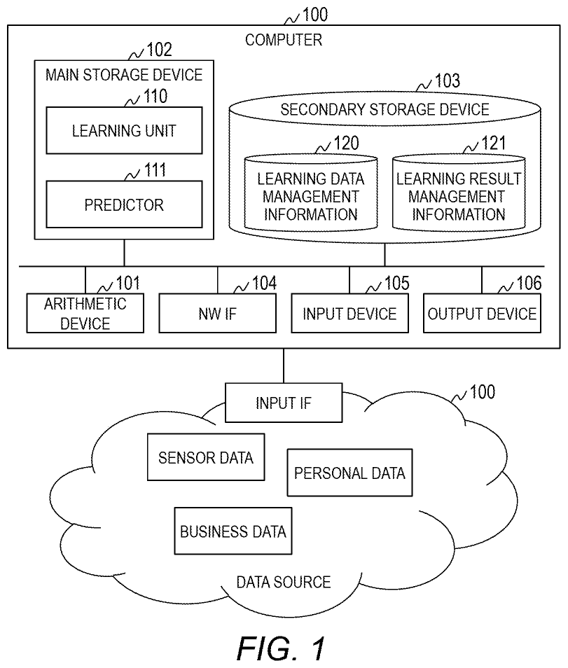

FIG. 1 is a diagram illustrating a configuration of a computer 100 according to Embodiment 1.

The computer 100 generates a model that outputs an output value (KPI) by processing different types of input data and outputs a plurality of types of output values using the model.

In Embodiment 1, a model in which time-series input data (time-series data) is input as data set, and which outputs an arbitrary output value is a target. The time-series data includes sensing data obtained in real time, quantitative data input manually in a time-series order, and other data.

The computer 100 includes an arithmetic device 101, a main storage device 102, a secondary storage device 103, a network interface 104, an input device 105, and an output device 106. These respective hardware components are connected via an internal bus.

The arithmetic device 101 is a Central Processing Unit (CPU), a Field Programmable Gate Array (FPGA), and a Graphics Processing Unit (GPU), and executes a program stored in the main storage device 102. The arithmetic device 101 executes processes according to the program whereby it operates as a functional unit (module) that realizes a specific function. In the following description, when a process is described using a functional unit as a subject, it indicates that the arithmetic device 101 executes a program that realizes the functional unit.

The main storage device 102 is a Dynamic Random Access Memory (DRAM) or the like, and stores a program to be executed by the arithmetic device 101 and various pieces of information. Moreover, the main storage device 102 includes a work area that is temporarily used by a program.

In the main storage device 102 of Embodiment 1, programs that realize the learning unit 110 that generates a model and the predictor 111 that outputs an output value using the model are stored.

The model of Embodiment 1 is a model that handles time-series data. The learning unit 110 and the predictor 111 may be mounted in separate computers. That is, a computer system may include the computer 100 that performs learning and the computer 100 that performs prediction.

The program and information stored in the main storage device 102 may be stored in the secondary storage device 103. In this case, the arithmetic device 101 reads the program and information from the secondary storage device 103 and loads the same into the main storage device 102.

The secondary storage device 103 is a Hard Disk Drive (HDD) and an Solid State Drive (SSD), and stores data permanently.

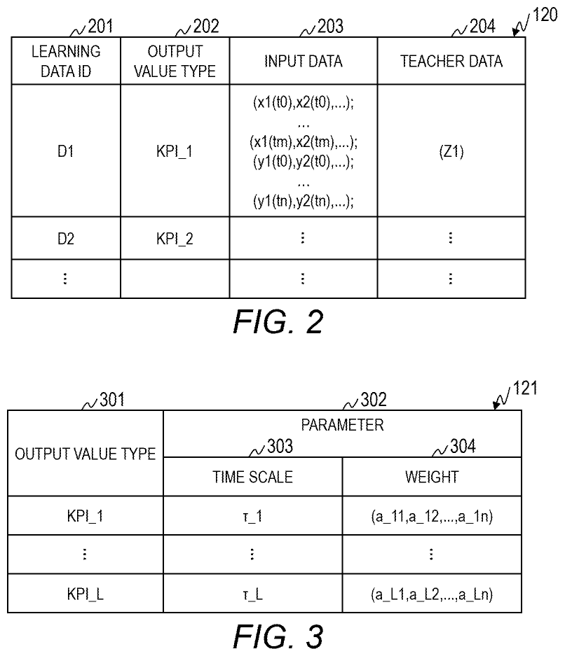

In Embodiment 1, the secondary storage device 103 stores learning data management information 120 for managing learning data and learning result management information 121 for managing learning results. The details of a data structure of the learning data management information 120 will be described with reference to FIG. 2, and the details of a data structure of the learning result management information 121 will be described with reference to FIG. 3.

The network interface 104 is an interface for communicating with other devices via a network. The input device 105 is a device for inputting data and commands to the computer 100 and includes a keyboard, a mouse, and a touch panel. The output device 106 is a device for outputting data and processing results from the computer 100 and includes a display and a printer. Moreover, the output device 106 may include a device used for virtual reality and augmented reality.

The computer 100 may be connected to the input device 105 and the output device 106 via an JO interface (not illustrated). The computer 100 may output data and processing results to an external terminal or an external server connected via the network interface 104 or the like.

The computer 100 obtains data used for learning or simulation from the data source 150. The data obtained from the data source 150 includes sensor data related to an environment such as temperature and noise, business data such as position information of school and demographic information, personal data such as a moving route of a person, and a commercial data such as a Point of Sales data (POS data). The present invention is not limited to the types and the number of data handled by the computer 100.

The computer 100 obtains data from the data source 150 via an input interface 160. For example, a sensor, an external server, a personal terminal, and a commercial terminal function as the input interface 160.

The data of the data source 150 may be stored in a data center (not illustrated). In this case, the data center functions as the input interface 160. The data center that stores the data of the data source 150 may execute preprocessing such as correction of data such as adjustment of a signal amplitude and data conversion such as conversion to quantitative data.

FIG. 2 is a diagram illustrating an example of a data structure of the learning data management information 120 of Embodiment 1.

The learning data management information 120 includes an entry formed of a learning data ID 201, an output value type 202, input data 203, and teacher data 204. One entry is present for one piece of learning data.

The learning data ID 201 is a field for storing identification information on learning data.

The output value type 202 is a field for storing information indicating the type of an output value.

The input data 203 is a field for storing a data set to be input to the learning unit 110. At least one data set is stored in the input data 203.

A plurality of different types of data sets may be stored in the input data 203. The type of input data, a time width handled as time-series data, and the like rather than data itself may be stored in the input data 203. In this case, a data set is obtained from the data source 150 or a data center on the basis of the input data 203.

The teacher data 204 is a field for storing teacher data. In Embodiment 1, an arbitrary KPI value is stored as teacher data.

The data structure of the learning data management information 120 illustrated in FIG. 2 is an example and is not limited thereto. For example, a data structure such as a CSV format may be used.

FIG. 3 is a diagram illustrating an example of a data structure of the learning result management information 121 of Embodiment 1.

The learning result management information 121 includes an entry formed of an output value type 301 and a parameter 302. One entry is present for one output value.

The output value type 301 is a field for storing information related to the type of an output value. The name or the like of an output value, for example, is stored in the output value type 301.

The parameter 302 is a field group for storing parameters to be used when calculating an output value corresponding to the output value type 301. The parameter 302 includes a time scale 303 and a weight 304.

The time scale 303 is a field for storing a time scale which is a parameter for adjusting a sampling interval. The details of the time scale will be described later. The weight 304 is a field for storing a weight for defining a model.

The data structure of the learning result management information 121 illustrated in FIG. 3 is an example and is not limited thereto. For example, a data structure such as a CSV for mat may be used.

First, the details of the configuration of process of the learning unit 110 will be described.

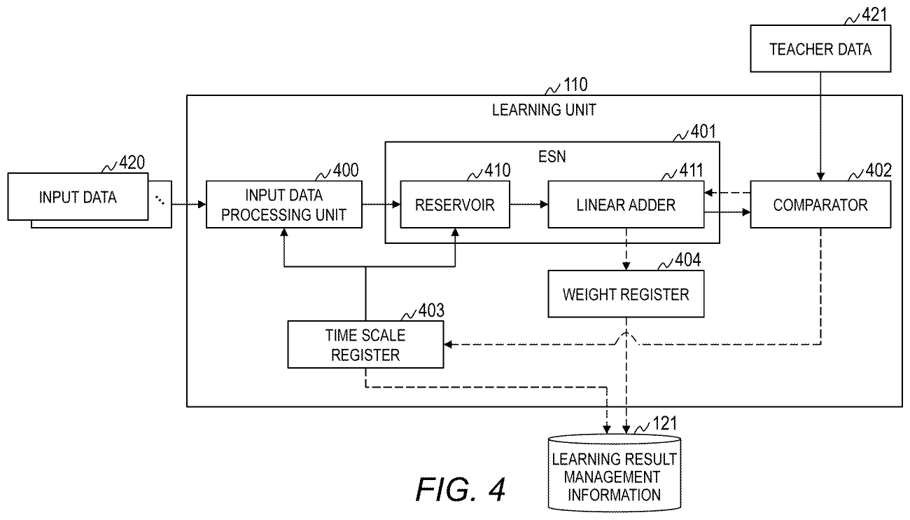

FIG. 4 is a diagram illustrating an example of a functional block of the learning unit 110 of Embodiment 1.

The learning unit 110 includes an input data processing unit 400, an ESN 401, a comparator 402, a time scale register 403, and a weight register 404.

The time scale register 403 is a register that stores a time scale. The time scale register 403 may be realized using a part of a storage area of the main storage device 102 or the secondary storage device 103 and may be realized using exclusive hardware.

A sampling interval of data sets needs to be adjusted depending on a difference in time correlation between an output value and input data. Therefore, in Embodiment 1, the time scale register 403 is provided to adjust the sampling interval. The weight register 404 is a register that stores a learning target weight in the ESN 401. The weight register 404 may be realized using a part of a storage area of the main storage device 102 or the secondary storage device 103 and may be realized using exclusive hardware.

The input data processing unit 400 executes a predetermined process on the input data 420 and inputs the processed input data 420 to the ESN 401. For example, the input data processing unit 400 executes the following processes.

(Process A1)

The amplitudes or the like of the pieces of input data 420 are generally not uniform. Moreover, the input data 420 includes data including a non-quantified value such as a questionnaire result. Therefore, the input data processing unit 400 performs data conversion such as data correction, adjustment of a signal amplitude, and quantification.

(Process A2)

Moreover, a difference (that is, a time interval) in time information included in the input data 420 that forms time-series data is generally not uniform. Therefore, the input data processing unit 400 calculates a time interval. For example, the time interval of the input data 420 related to national tax investigation is five years and the time interval of the input data 420 related to weather is one hour.

(Process A3)

The input data processing unit 400 executes a process of adjusting the time interval of data sets. The time interval can be adjusted easily when it is adjusted on the basis of the smallest value of the time intervals of the input data 420 included in the data source. For example, when the time interval between first input data 420 and second input data 420 is larger than a reference time interval, the input data processing unit 400 complements the input data 420 using a known interpolation method.

(Process A4)

The input data processing unit 400 performs sampling to select input data to be input to the learning unit 110 from the data sets on the basis of the sampling interval.

In the following description, processes other than sampling will be referred to as preprocessing. When data is stored in a data center, the data center may execute preprocessing.

The ESN 401 derives an output value from the input data 420. The ESN 401 includes a reservoir 410 and a linear adder 411. The details of the structure of the ESN 401 will be described later.

The comparator 402 compares the output value output from the ESN 401 with teacher data 421 to update a model (a weight) on the basis of the comparison result. For example, the comparator 402 updates the model using the least squares method so that a difference between two values decreases.

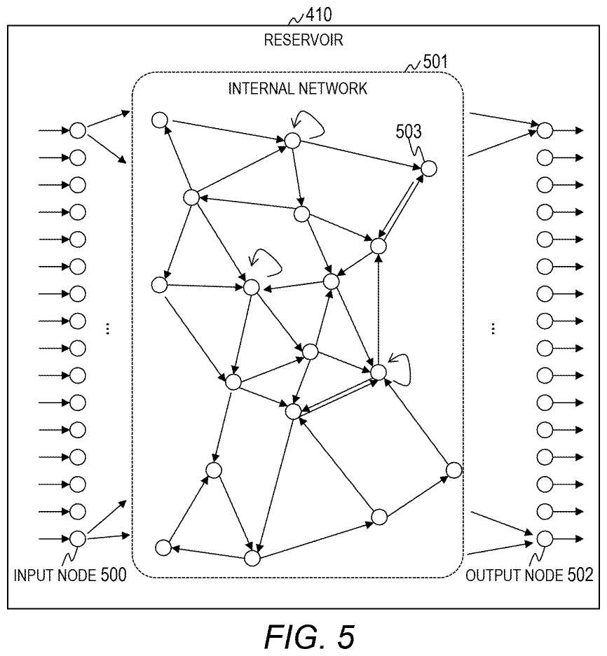

Here, the structure of the ESN 401 will be described. FIG. 5 is a diagram illustrating an example of the structure of the reservoir 410 of Embodiment 1.

The reservoir 410 includes a plurality of input nodes 500, an internal network 501 including a plurality of internal nodes 503, and a plurality of output nodes 502. The internal network 501 includes connections of recursive structures of the internal nodes 503. In the example illustrated in FIG. 5, the numbers of input nodes 500 and output nodes 502 each are sixteen, and the internal network 501 includes eighteen internal nodes 503. The number of nodes included in the actual reservoir 410 is very large. For example, 100 or more internal nodes 503 may be included in the internal network 501.

In the following description, the input node 500, the output node 502, and the internal node 503 will be referred to as a node when they are not distinguished from each other.

FIG. 5 illustrates a logical structure of the reservoir 410 and does not illustrate a physical structure. That is, a node represents a function of storing a value indicating an internal state, performing an operation of nonlinear conversion using the value and values (signals) input from other nodes to update the internal state, and outputting an operation result. Moreover, a line (an arrow) connecting the nodes represents a function of transferring values (signals). The output of values (signals) between nodes is performed according to a fixed time step.

A weight is set to a line connecting the nodes. A value obtained by multiplying the value of a transfer source node by the weight is transferred to a transfer destination node.

The details of data processing (signal processing) of the reservoir 410 are disclosed in Jaeger H. and Haas H., Harnessing nonlinearity: “Predicting chaotic systems and saving energy in wireless communication”, Science, 304, pp. 78-80, 2004, and an overview thereof will be described herein.

The input node 500 receives input signals and outputs a nonlinearly converted value to the internal network 501 and the output node 502 without a delay. The internal node 503 is connected to any one of the other internal node 503 and the output node 502. In a case where the connection destination of the internal node 503 is the other internal node 503, the internal node 503 outputs a value to the other internal node 503 with a delay of one time step. In a case where the connection destination of the internal node 503 is the output node 502, the internal node 503 outputs a value to the output node 502 without a delay.

The output node 502 is connected to any one of the internal node 503 and the other output node 502. Moreover, the output node 502 is also connected to the outside (the linear adder 411). The output node 502 outputs a value to the internal node 503 or the other output node 502 connected thereto with a delay of one time step and outputs a value to the outside (the linear adder 411) without a delay.

The linear adder 411 is connected to the output node 502 of the reservoir 410 and adds a value obtained by multiplying the value output from the output node 502 by a weight to the value and outputs the addition result as an output value.

The coupling and the weight of the reservoir 410 are fixed and are not updated during a learning process. Moreover, the connection of the reservoir 410 and the linear adder 411 is fixed and is not updated during a learning process. On the other hand, the weight of the connection of the reservoir 410 and the linear adder 411 is updated during a learning process.

As described with regard to a time scale, the sampling interval of the input data 420 input to a model that calculates an output value has an optimal time interval. Therefore, in Embodiment 1, the time scale is also updated during a learning process. Moreover, by synchronizing the sampling interval with the time step of the ESN 401, it is possible to further decrease a difference between an output value and teacher data.

In Embodiment 1, the learning unit 110 stores the parameters stored in the time scale register 403 and the weight register 404 after a learning process ends in the learning result management information 121 as a learning result.

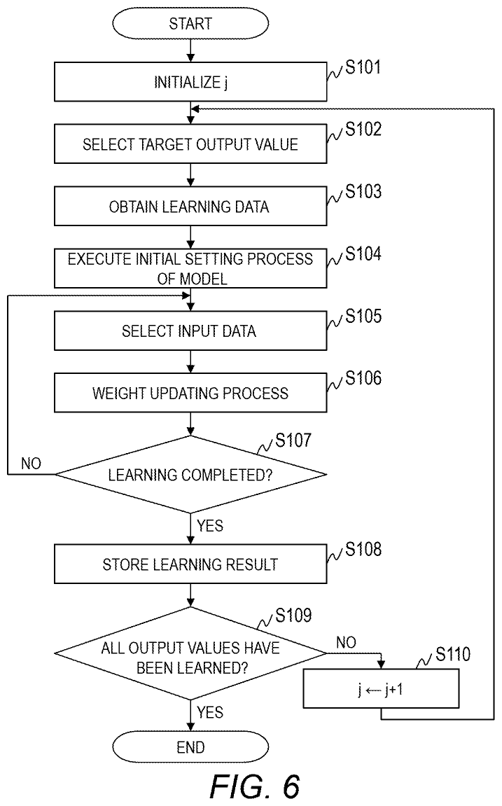

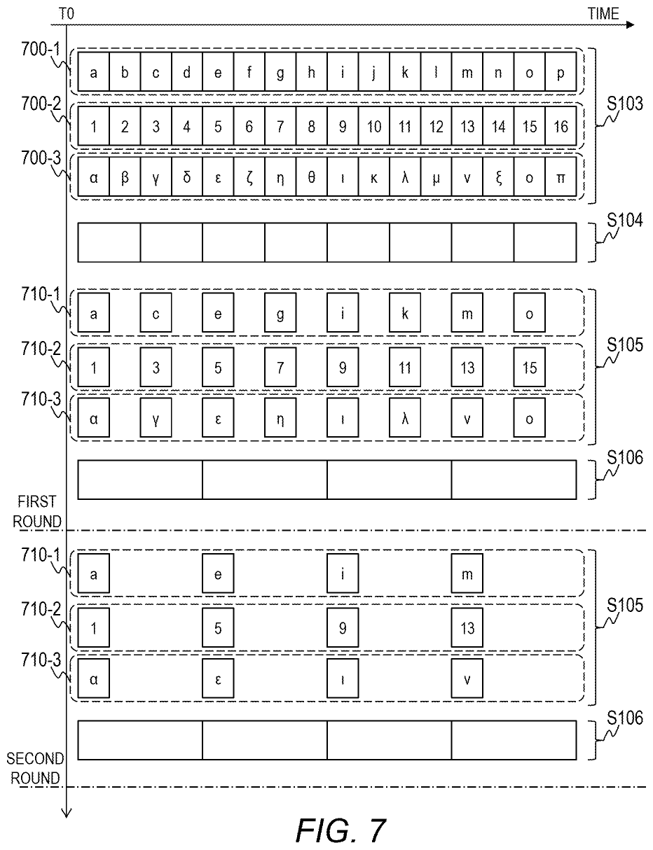

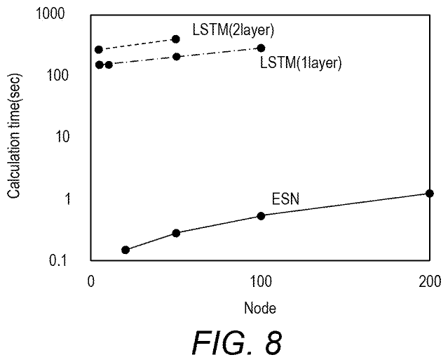

FIG. 6 is a flowchart for describing a learning process executed by the learning unit 110 of Embodiment 1. FIG. 7 is a diagram illustrating an example of specific data processing of the learning process of Embodiment 1. FIG. 8 is a graph illustrating a difference between the learning process of Embodiment 1 and a conventional learning process.

In a case of receiving a learning process execution instruction, the learning unit 110 starts a learning process to be described below. The learning process may be executed periodically.

The learning unit 110 initializes a variable j (step S101). Here, the variable j is a suffix for identifying an output value (KPI). In this step, the variable j is set to 1. Subsequently, the learning unit 110 selects a target output value (step S102).

Specifically, the learning unit 110 selects an output value corresponding to the variable j as a target output value.

Subsequently, the learning unit 110 obtains learning data from the learning data management information 120 (step S103).

Specifically, the learning unit 110 retrieves an entry in which the type of the target output value is set in the output value type 202. The learning unit 110 obtains learning data corresponding to the retrieved entry.

Subsequently, the learning unit 110 executes an initial setting process of a model (step S104). Specifically, the following processes are executed.

The learning unit 110 performs initial setting of the ESN 401 (model) by setting an initial value of a weight. The initial value of the weight is stored in the weight register 404. The initial value of the weight may be set randomly and may be set on the basis of an arbitrary algorithm.

Moreover, the learning unit 110 deter nines a time scale and stores the time scale in the time scale register 403. For example, the learning unit 110 sets the smallest value of the sampling time intervals of all data sets as the initial value. The initial value of the time scale may be set on the basis of an algorithm and may be input by a user.

Subsequently, the learning unit 110 selects input data 420 by performing sampling on the basis of the time scale set in the time scale register 403 (step S105).

Specifically, after executing preprocessing on the input data 420, the input data processing unit 400 performs sampling on the basis of the time scale to select pieces of input data 420. Moreover, the input data processing unit 400 inputs learning time-series data composed of the selected pieces of input data 420 to the ESN 401.

Subsequently, the learning unit 110 executes a weight updating process using the learning time-series data composed of the selected pieces of input data 420 (step S106). Specifically, the following processes are executed.

The ESN 401 inputs the pieces of input data 420 that for in the learning time-series data to the reservoir 410 with a delay of a time step corresponding to the time scale. Furthermore, the ESN 401 inputs the output result of the reservoir 410 to the linear adder 411. The linear adder 411 calculates an output value by executing weighted addition of the output result of the reservoir 410. The ESN 401 inputs the output value to the comparator 402 after all pieces of input data 420 that form the learning time-series data are input and a process corresponding to a predetermined time step is executed.

The comparator 402 updates the weight and the time scale of the ESN 401 on the basis of the comparison result between the output value and the teacher data 421.

For example, the learning unit 110 may calculate a local minimum value of an error value indicating an error between the output value and the teacher data 421 using the sampling interval as a variable and may use a known method such as a gradient method. The weight may be updated by a method of settling to a smallest value of an error value rather than settling to a local minimum value. In this case, a known method such as adding perturbation to a method of changing the weight may be used.

The comparator 402 calculates an error value indicating an error between the output value and the teacher data 421 and deter mines whether the present error value is smaller than the error value stored in the work area. In a case where the present error value is smaller than the error value stored in the work area, the comparator 402 stores the present error value in the work area. Moreover, the comparator 402 stores the updated time scale in the time scale register 403 and outputs a weight storage instruction to the linear adder 411. In a case of receiving the weight storage instruction, the linear adder 411 stores the updated weight in the weight register 404.

Hereinabove, the process of step S106 has been described.

Subsequently, the learning unit 110 determines whether or not to end the learning (step S107).

Specifically, the learning unit 110 deter mines whether the ESN 401 (model) in which the error value or the rate of change of the error value is smaller than a threshold has been generated. In a case where the ESN 401 (model) in which the error value or the rate of change of the error value is smaller than a threshold is generated, the learning unit 110 determines to end the learning. The learning unit 110 may determine to end the learning in a case where the number of executions of the weight updating process is larger than a threshold.

In a case where it is determined that the learning is not to be ended, the learning unit 110 returns to step S105 and executes similar processes.

In a case where it is determined that the learning is to be ended, the learning unit 110 stores the learning result in the learning result management information 121 (step S108).

Specifically, the learning unit 110 adds an entry to the learning result management information 121 and sets the identification information of the target output value to the output value type 301 of the added entry. The learning unit 110 sets the time scale stored in the time scale register 403 to the time scale 303 of the added entry and sets the weight stored in the weight register 404 to the weight 304.

Subsequently, the learning unit 110 determines whether learning of all output values has been completed (step S109).

In a case where it is deter mined that the learning of all output values has not been completed, the learning unit 110 updates the variable j (step S110), and then, returns to step S102.

Specifically, the learning unit 110 sets a value obtained by adding 1 to the variable j as the variable j.

In a case where it is deter mined that the learning of all output values has been completed, the learning unit 110 ends the learning process.

Here, the flow of the learning process will be described with reference to FIG. 7.

In step S103, it is assumed that data sets 700-1, 700-2, and 700-3 having different data types are obtained. Moreover, it is assumed that the input data processing unit 400 has executed preprocessing so that the smallest values (t) of the time intervals of the data sets 700 are the same.

In step S103, the learning unit 110 sets twice the smallest value (t) of the time interval of the data set 700 as a time scale.

In step S105, the learning unit 110 selects the input data 420 from the data sets 700-1, 700-2, and 700-3 in units of time scale and generates pieces of learning time-series data 710-1, 710-2, and 710-3.

In step S106, the learning unit 110 updates the weight and the time scale using the learning time-series data 710.

In a case where it is deter mined in step S107 that the learning process is not to be ended, the learning unit 110 selects the input data 420 from the data set 700 in units of time scale in step S105.

In step S105, the learning unit 110 selects the input data 420 from the data sets 700-1, 700-2, and 700-3 as the selected input data 420 and generates pieces of learning time-series data 710-1, 710-2, and 710-3.

In step S106, the learning unit 110 updates the weight and the time scale using the learning time-series data 710. In this case, when the present error value is larger than the previous error value, the values of the time scale register 403 and the weight register 404 are not updated.

In conventional machine learning such as deep learning and Long Short-Term Memory (LSTM), the weight of connection between nodes is learned for a combination of nodes. For example, the number of weights is on the order of the square of the number of internal nodes when only internal nodes are focused on. Therefore, when the size of a neural network increases, the amount of calculation required for machine learning becomes enormously large, and a calculation cost such as a calculation time and power consumption increases.

On the other hand, the weight of connection between the output node 502 and the linear adder 411 is the only thing learned by the ESN, and the number of internal nodes 503 has a small influence on the amount of calculation. Therefore, the calculation cost required for machine learning can be reduced remarkably as compared to conventional machine learning. Furthermore, the number of output nodes can be adjusted freely to an extent that it has little influence on prediction accuracy.

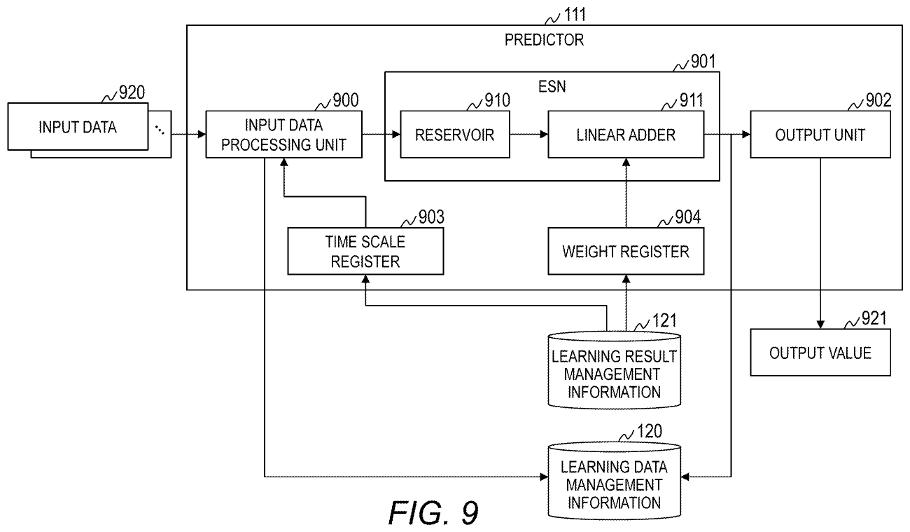

In Embodiment 1, the learning unit 110 learns the weight between the output node 502 and the linear adder 411 for each output value using the ESN 401 including the reservoir 410 having the same structure. In this way, it is possible to shorten the learning time. Moreover, as will be described later, a plurality of output values can be calculated using one ESN 901 (see FIG. 9) by switching the weights. Moreover, since the learning result is the weight between the output node 502 and the linear adder 411, it is possible to reduce the storage area in which the learning result is stored.

Here, a difference between the learning process of Embodiment 1 and a learning process based on LSTM will be described. FIG. 8 is a graph that compares the calculation time of ESN of Embodiment 1 and LSTM. A horizontal axis of the graph of FIG. 8 represents the number of internal nodes and a vertical axis represents a calculation time. The number of internal nodes is the same for ESN and LSTM.

As illustrated in FIG. 8, it is understood that the calculation time of ESN is approximately 1000 times shorter than the calculation time of LSTM. This is based on the fact that the number of parameters (weights) to be learned is small and the relation between parameters is not complex. When the number of pieces of input data and the number of types thereof increase, since it is necessary to increase the number of internal nodes to increase simulation accuracy, it is preferable to use ESN from the viewpoint of a server load.

Next, the details of the configuration and the process of the predictor 111 will be described.

FIG. 9 is a diagram illustrating an example of a functional block of the predictor 111 of Embodiment 1.

The predictor 111 includes an input data processing unit 900, an ESN 901, an output unit 902, a time scale register 903, and a weight register 904.

The input data processing unit 900 is the same as the input data processing unit 400. Input data 920 used for a prediction process is input to the input data processing unit 900. The ESN 901 is the same as the ESN 401. Moreover, the time scale register 903 and the weight register 904 are the same as the time scale register 403 and the weight register 404.

The output unit 902 outputs an output value 921 output from the ESN 901.

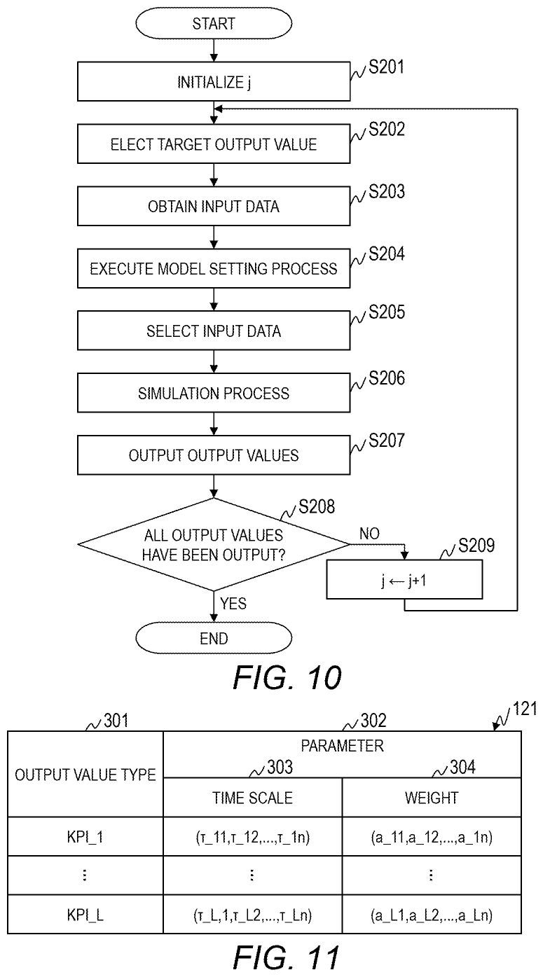

FIG. 10 is a flowchart for describing a prediction process executed by the predictor 111 of Embodiment 1.

In a case of receiving a prediction process execution instruction, the predictor 111 starts a prediction process to be described below. The prediction process may be executed periodically.

The predictor 111 initializes a variable j (step S201). Here, the variable j is a suffix for identifying the output value (KPI). In this step, the variable j is set to 1.

Subsequently, the predictor 111 selects a target output value (step S202).

Specifically, the predictor 111 selects an output value corresponding to the variable j as a target output value.

Subsequently, the predictor 111 obtains input data 920 to be used for a simulation process (step S203).

Specifically, the predictor 111 obtains input data 920 from the data source 150 or a data center.

Subsequently, the predictor 111 executes a model setting process (step S204). Specifically, the predictor 111 refers to the learning result management information 121 to retrieve an entry in which the type of the target output value is set in the output value type 301. The predictor 111 sets a time scale and a weight on the basis of the parameter 302 of the retrieved entry. In this way, a model for calculating the target output value is constructed.

Subsequently, the predictor 111 selects input data 920 by performing sampling on the basis of the time scale set in the time scale register 903 (step S205).

Specifically, after executing preprocessing on the input data 920, the input data processing unit 900 performs sampling on the basis of the time scale to select pieces of input data 920. Moreover, the input data processing unit 900 inputs analysis time-series data composed of the selected pieces of input data 920 to the ESN 401.

Subsequently, the predictor 111 executes a simulation process using the analysis time-series data composed of the selected pieces of input data 920 (step S206).

Specifically, the ESN 401 inputs the pieces of input data 920 that for m the analysis time-series data to the reservoir 910 with a delay of a time step corresponding to the time scale. Further more, the ESN 401 inputs an output result of the reservoir 910 to the linear adder 911. The linear adder 911 calculates the output value by executing weighted addition of the output result of the reservoir 910. The ESN 401 inputs the output value to the output unit 902 after all pieces of input data 920 that for m the analysis time-series data are input and a process corresponding to a predetermined time step is executed.

Hereinabove, the process of step S206 has been described.

Subsequently, the predictor 111 outputs the prediction result (step S207).

Specifically, the output unit 902 outputs the output value 921 to the output device 106 or outputs the output value 921 to an external device connected via the network interface 104. In this case, the predictor 111 may generate a data set composed of pieces of input data 920 and teacher data 421 composed of the output values 921 and store the same in the learning data management information 120. In this manner, it is possible to enhance prediction accuracy over time by storing learning data necessary for a learning process and executing the learning process using the learning data.

Subsequently, the predictor 111 determines whether the output of all output values has been completed (step S208).

In a case where it is determined that the output of all output values has not been completed, the predictor 111 updates the variable j (step S209) and after that, returns to step S202.

Specifically, the predictor 111 sets a value obtained by adding 1 to the variable j as the variable j.

In a case where it is determined that the output of all output values has been completed, the predictor 111 ends the prediction process.

In Embodiment 1, it is possible to calculate a plurality of output values by setting the weight and the time scale of each output value to one predictor 111 as internal parameters.

Next, a specific utilization method of the computer 100 described in Embodiment 1 will be described.

In this example, it is assumed that a model for calculating a traffic volume and a degree of activity which are KPIs representing the state of a town from data sets Sa and Sb is generated.

(Case 1)

When a model in which a new data set Sc is added is generated, the learning data is updated, and the learning unit 110 executes the processes of steps S103 to S108 with respect to each of the traffic volume and the degree of activity.

(Case 2)

When it is found from the recent situation that supplementary data Sa′ of the data set Sa also contributes to the traffic volume and the degree of activity, the learning data is updated, and the learning unit 110 executes the processes of steps S103 to S108 with respect to each of the traffic volume and the degree of activity.

(Case 3)

When a land price is necessary as a KPI, the learning data is updated, and the learning unit 110 executes the processes of steps S103 to S108 and generates a model for calculating the land price.

By visualizing the KPI group, it can be provided as information indicating the land price of the city of interest, the basis of the assessment, and the like. Examples of the KPI of city planning include the degree of perfection of educational support, the coverage of disaster prevention equipment, and cultural activities.

Moreover, it is possible to evaluate the validity of a KPI by generating a model for calculating an assumed KPI such as an area value. By specifying an appropriate KPI, it can be used as an index for formulating financial products such as insurance.

Moreover, it is possible to evaluate the validity of a KPI by generating a model for calculating a KPI that can visualize the characteristics of a region including qualitative characteristics. By specifying an appropriate KPI, it can be used as an index for continuing the effectiveness and effect of town revitalization and programs.

In this manner, the computer 100 of Embodiment 1 can generate a model corresponding to a typical case of city planning quickly and at low cost.

As described above, according to Embodiment 1, the computer 100 capable of calculating a plurality of output values from a plurality of data sets (time-series data) having different data types can be realized with a small calculation cost. Such a computer 100 can flexibly cope with data-driven city planning.

### Embodiment 2

In Embodiment 2, the configurations of the functional blocks of the learning unit 110 and the predictor 111 are partially different from those of Embodiment 1. Hereinafter, a difference between Embodiment 2 and Embodiment 1 and the like will be described mainly.

A hardware configuration and a software configuration of the computer 100 of Embodiment 2 are the same as those of Embodiment 1. A data structure of the learning data management information 120 of Embodiment 2 is the same as that of Embodiment 1.

In Embodiment 2, the data stored in the learning result management information 121 is partially different from that of Embodiment 1. FIG. 11 is a diagram illustrating an example of a data structure of the learning result management information 121 of Embodiment 2.

A combination of time scales of respective pieces of input data 420 is stored in the time scale 303 of the entry included in the learning result management information 121.

In this manner, in Embodiment 2, the time scale is set for each input data 420 as a parameter for calculating one output value.

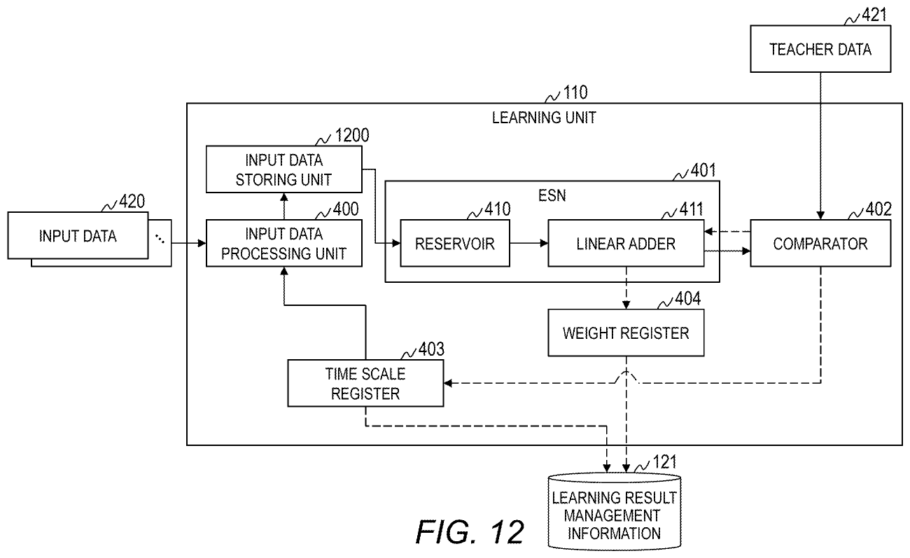

In Embodiment 2, a configuration of a functional block of the learning unit 110 is different from that of Embodiment 1. FIG. 12 is a diagram illustrating an example of a functional block of the learning unit 110 of Embodiment 2.

The learning unit 110 of Embodiment 2 further includes an input data storing unit 1200. The other functional blocks are the same as those of Embodiment 1.

The input data storing unit 1200 stores the input data 420 processed by the input data processing unit 400. Moreover, the input data storing unit 1200 inputs the stored input data 420 to the ESN 401. The input data storing unit 1200 may be realized using a part of a storage area of the main storage device 102 or the secondary storage device 103 and may be realized using exclusive hardware.

In Embodiment 2, the time scale stored in the time scale register 403 is input to the input data processing unit 400 only.

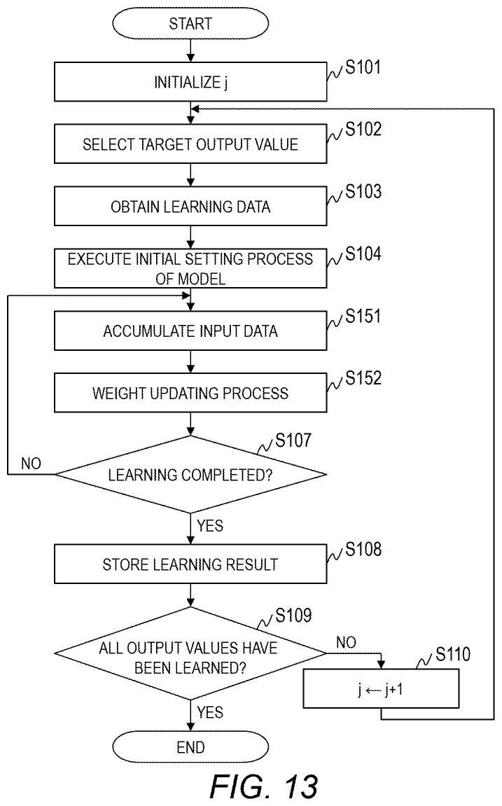

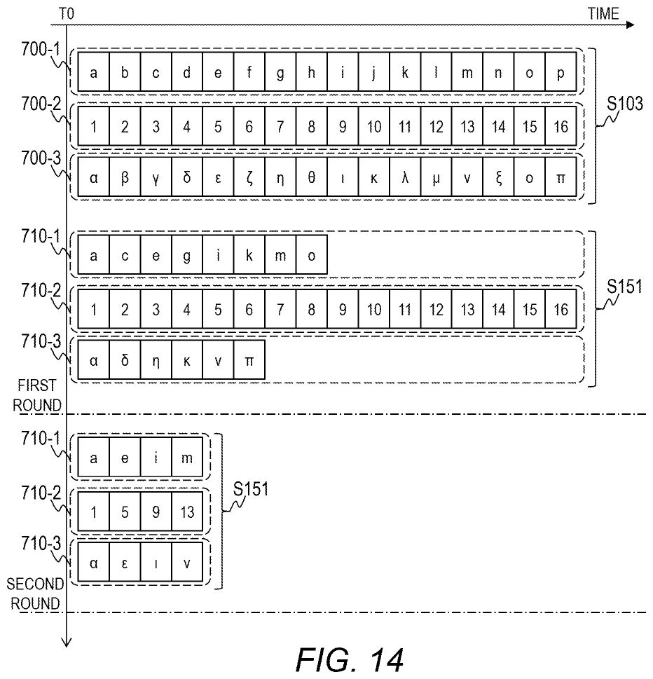

FIG. 13 is a flowchart for describing a learning process executed by the learning unit 110 of Embodiment 2. FIG. 14 is a diagram illustrating an example of specific data processing of the learning process of Embodiment 2.

The processes of steps S101 to S104 are the same as the processes of Embodiment 1. However, in step S104, the time scale is deterrmined for each type of the input data 420.

After the process of step S104 is executed, the learning unit 110 selects the input data 420 by performing sampling on the basis of the time scale set in the time scale register 403 and stores the selected input data 420 in the input data storing unit 1200 (step S151). Specifically, the following processes are executed.

(step S151-1) The input data processing unit 400 selects the type of acquisition target input data 420 and obtains the time scale corresponding to the target input data 420 from the time scale register 403.

(step S151-2) The input data processing unit 400 performs sampling according to the obtained time scale to select pieces of input data 420. Moreover, the input data processing unit 400 stores the learning time-series data composed of the selected pieces of input data 420 in the input data storing unit 1200.

The input data processing unit 400 executes steps S151-1 and S151-2 with respect to all data types.

Subsequently, the learning unit 110 executes a weight updating process using the learning time-series data (step S152). Specifically, the following processes are executed.

The input data processing unit 400 obtains pieces of input data 420 corresponding to one time step from the input data storing unit 1200 and inputs the obtained pieces of input data 420 in the ESN 401. The ESN 401 executes processes according to a known process. The ESN 401 inputs the output value to the comparator 402 after all pieces of input data 420 that for in the learning time-series data are input and a process corresponding to a predetermined time step is executed.

The comparator 402 updates the weight and the time scale of the ESN 401 on the basis of the comparison result between the output value and the teacher data 421. For example, a local minimum value of an error value using each time scale as a variable may be calculated.

The processes of steps S107 to S110 are the same as those of Embodiment 1.

In Embodiment 1, the time steps are adjusted so that the sampling intervals of pieces of input data 420 included in the learning time-series data of each data type are the same. On the other hand, in Embodiment 2, it is not necessary to adjust the time steps of the ESN 401 for each type of the input data 420. In this way, the ESN 401 can process the pieces of input data 420 having different time intervals in the same time step. In this way, the learning accuracy is improved remarkably.

Here, the flow of the learning process will be described with reference to FIG. 14.

In step S104, it is assumed that the time scale of the data set 700-1 is set to 2t, the time scale of the data set 700-2 is set to t, and the time scale of the data set 700-3 is set to 3t.

In step S151, the learning unit 110 performs sampling on the basis of the time scales from the data sets 700-1, 700-2, and 700-3 to select input data 420.

In step S152, the learning unit 110 gets one piece of input data 420 and inputs the same to the ESN 401 regardless of a difference in the time interval of the pieces of input data 420 included in the learning time-series data 710. The learning unit 110 updates the weight and the time scale using the learning time-series data 710.

For example, the learning unit 110 sets the time scales of the data sets 700-1, 700-2, and 700-3 to 4t.

In step S151, the learning unit 110 performs sampling on the basis of the time scales from the data sets 700-1, 700-2, and 700-3 to select input data 420.

In step S152, the learning unit 110 gets one piece of input data 420 and inputs the same to the ESN 401 regardless of a difference in the time interval of the pieces of input data 420 included in the learning time-series data 710. The learning unit 110 updates the weight and the time scale using the learning time-series data 710. After that, similar processes are executed.

For example, time intervals of the influences of pieces of input data on an output value are different in such a manner that the span of the influence of dioxide emission on temperature is several years whereas the span of the influence of sunshine is several days. Therefore, the input interval of the input data 420 is adjusted so that pieces of input data of different time intervals can be handled in one time step of the ESN 401. In this way, it is possible to further decrease a difference between the teacher data 421 and the output value and generate a model having high prediction accuracy.

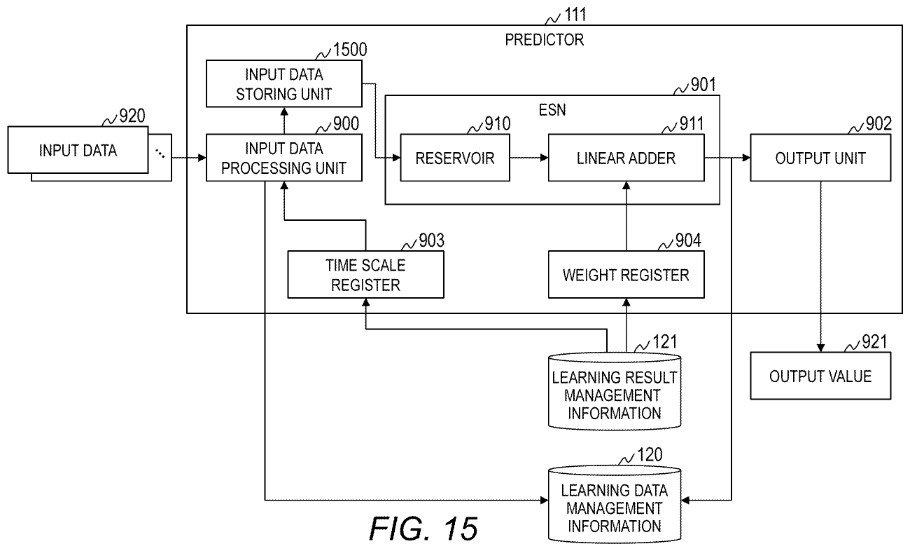

In Embodiment 2, a configuration of a functional block of the predictor 111 is different from that of Embodiment 1. FIG. 15 is a diagram illustrating an example of a functional block of the predictor 111 of Embodiment 2.

The predictor 111 of Embodiment 2 further includes an input data storing unit 1500. The other functional blocks are the same as those of Embodiment 1.

The input data storing unit 1500 is the same as the input data storing unit 1200. Moreover, in Embodiment 2, the time scale stored in the time scale register 903 is input to the input data processing unit 900 only.

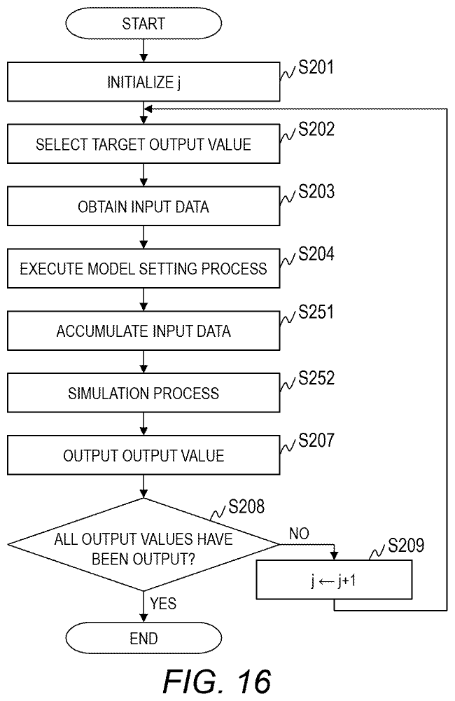

FIG. 16 is a flowchart for describing a prediction process executed by the predictor 111 of Embodiment 2.

The processes of steps S201 to S204 are the same as the processes of Embodiment 1. However, in step S204, the time scale is deter mined for each type of the input data 420.

After the process of step S204 is executed, the predictor 111 selects the input data 920 by performing sampling on the basis of the time scale set in the time scale register 903 and stores the selected input data 920 in the input data storing unit 1500 (step S251).

Subsequently, the predictor 111 selects pieces of input data 420 corresponding to one time step from the input data storing unit 1500 and inputs the selected pieces of input data 420 to the ESN 401 (step S252). After that, the predictor 111 proceeds to step S206. Specifically, the following processes are executed.

The input data processing unit 900 obtains pieces of input data 920 corresponding to one time step from the input data storing unit 1500 and inputs the selected pieces of input data 920 to the ESN 901. The ESN 901 executes processes according to a known process.

The ESN 901 inputs the output value to the output unit 902 after all pieces of input data 920 that for in the learning time-series data are input and a process corresponding to a predetermined time step is executed.

The processes of steps S207 to S209 are the same as those of Embodiment 1.

According to Embodiment 2, it is possible to realize the computer 100 providing advantages similar to those of Embodiment 1. Moreover, it is possible to generate a model having high prediction accuracy.

### Embodiment 3

In Embodiment 3, the configurations of the functional blocks of the learning unit 110 and the predictor 111 are partially different from those of Embodiment 1. Hereinafter, a difference between Embodiment 3 and Embodiment 1 and the like will be described mainly.

A hardware configuration and a software configuration of the computer 100 of Embodiment 3 are the same as those of Embodiment 1. Data structures of the learning data management information 120 and the learning result management information 121 of Embodiment 3 are the same as those of Embodiment 1.

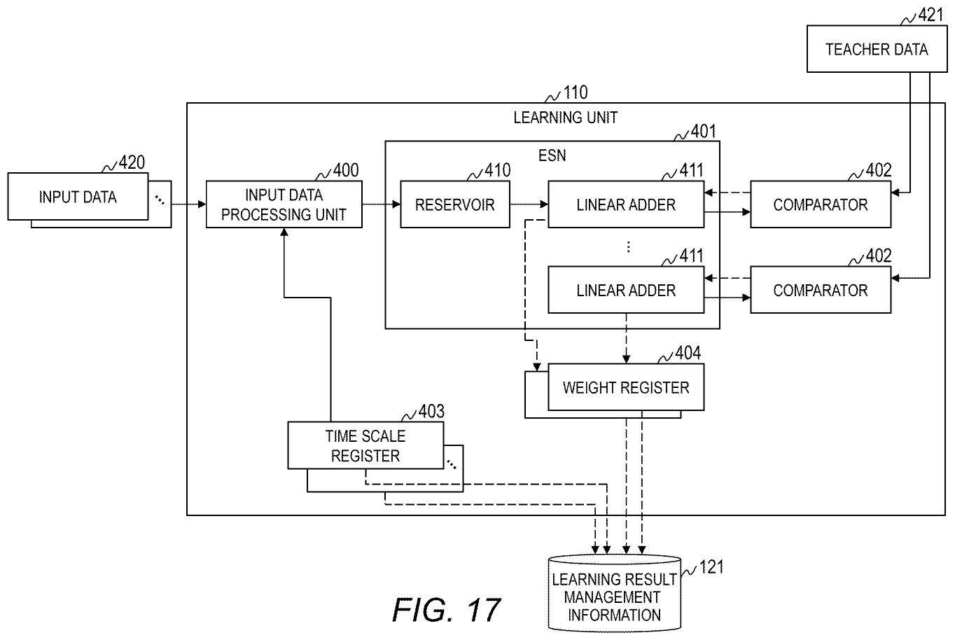

FIG. 17 is a diagram illustrating an example of a functional block of the learning unit 110 of Embodiment 3.

In Embodiment 3, the ESN 401 includes a plurality of linear adders 411. Moreover, the learning unit 110 includes a plurality of comparators 402 corresponding to the respective linear adders 411 and includes a plurality of weight registers 404. Furthermore, the learning unit 110 includes a plurality of time scale registers 403 corresponding to the respective comparators 402.

It is assumed that one pair of the linear adder 411 and the comparator 402 is present for one output value.

In Embodiment 3, the time scale is fixed to an initial value. Moreover, adjustment of the time step of the ESN 401 based on the time scale is not performed. Therefore, the time step and the sampling interval of the ESN 401 are the same.

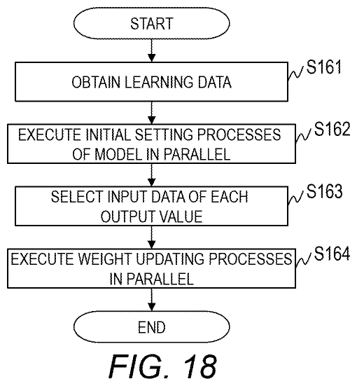

FIG. 18 is a flowchart for describing a learning process executed by the learning unit 110 of Embodiment 3.

The learning unit 110 obtains learning data for generating models each of which calculates an output value from the learning data management information 120 (step S161).

Subsequently, the learning unit 110 executes initial setting processes of a model in parallel (step S162).

Specifically, the learning unit 110 sets an initial value to the weight of the linear adder 411 and sets an initial value to each time scale register 403.

The smallest value of the time intervals of pieces of input data 420 included in all data sets or a common factor of the time intervals of different types of input data 420 is set as the initial value of the time scale.

Subsequently, the learning unit 110 selects the input data 420 of each output value by performing sampling on the basis of the time scale set in the time scale register 403 (step S163). The process of selecting the input data 420 is the same as the process of step S105.

Subsequently, the learning unit 110 executes weight updating processes in parallel using the learning time-series data composed of the selected pieces of input data 420 (step S164).

The weight updating process is similar to that of Embodiment 1. Each linear adder 411 outputs the output value to the comparator 402 according to the time scale. Moreover, the comparator 402 obtains the teacher data 421 according to the time scale and compares the output value and the teacher data 421. The comparator 402 updates the weight on the basis of the comparison result.

In a case where the weight updating process by the pair of the linear adder 411 and the comparator 402 is completed, the learning unit 110 outputs the values of the time scale register 403 and the weight register 404 corresponding to the pair of the linear adder 411 and the comparator 402 in parallel and stores the same in the learning result management information 121.

A register that correlates the values of the time scale register 403 and the weight register 404 corresponding to the pair of the linear adder 411 and the comparator 402 with each other may be prepared, and the learning unit 110 may store the output from the register in the learning result management information 121. The pair of one linear adder 411 and one comparator 402 may be allocated to a plurality of output values. In this case, the pair learns the weight for each output value.

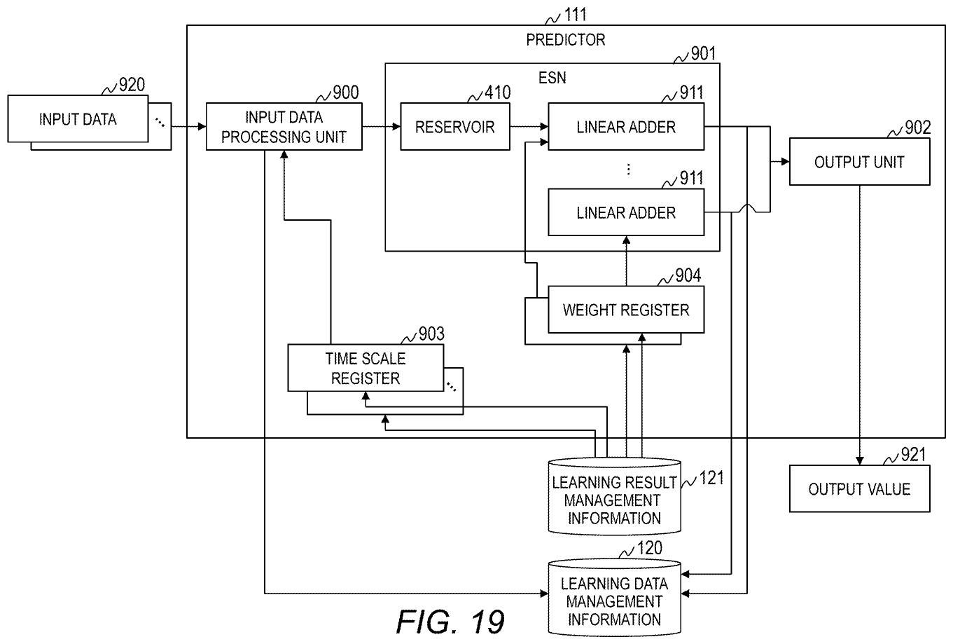

FIG. 19 is a diagram illustrating an example of a functional block of the predictor 111 of Embodiment 3.

In Embodiment 3, the ESN 901 includes a plurality of linear adders 911. Moreover, the predictor 111 includes a plurality of time scale registers 903 and a plurality of weight registers 904 corresponding to each linear adder 911.

It is assumed that one set composed of the linear adder 911, the time scale register 903, and the weight register 904 is present for one output.

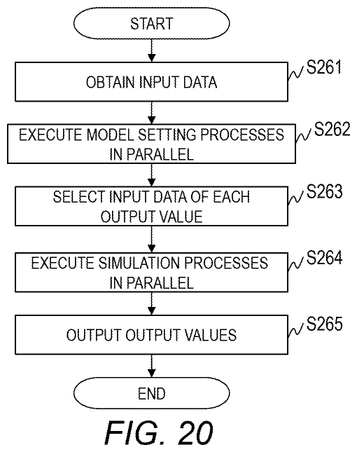

FIG. 20 is a flowchart for describing a prediction process executed by the predictor 111 of Embodiment 3.

Subsequently, the predictor 111 obtains the input data 920 for calculating each output value from the data source 150 (step S261).

Subsequently, the predictor 111 executes model setting processes in parallel (step S262).

Specifically, the predictor 111 sets a time scale to each time scale register 403 and sets a weight to each linear adder 911.

Subsequently, the predictor 111 selects the input data 920 of each output value by performing sampling on the basis of the time scale set in the time scale register 903 (step S263). The process of selecting the input data 920 is the same as the process of step S205.

Subsequently, the predictor 111 executes simulation processes in parallel using the analysis time-series data composed of the selected pieces of input data 920 (step S264). The simulation process is the same as that of Embodiment 1.

Subsequently, the predictor 111 outputs the prediction result (step S265).

Specifically, the output unit 902 outputs the output value 921 to the output device 106 or outputs the output value 921 to an external device connected via the network interface 104. In this case, the predictor 111 may generate a data set and the teacher data 421 composed of the output value 921 and store the same in the learning data management information 120.

One set may be allocated to a plurality of output values. In this case, the set switches parameters for respective output values to calculate the output values.

According to Embodiment 3, a calculation time for calculating a plurality of output values is shortened by executing simulation processes for calculating the plurality of output values in parallel.

Moreover, similarly to Embodiment 1, it is possible to flexibly cope with addition or change of an output value. Therefore, the present invention can be applied to a system such as on-time simulation that visualizes the current state of a city and the changes over time.

The present invention is not limited to the above embodiment and includes various modification examples. In addition, for example, the configurations of the above embodiment are described in detail so as to describe the present invention comprehensibly. The present invention is not necessarily limited to the embodiment that is provided with all of the configurations described. In addition, a part of each configuration of the embodiment may be removed, substituted, or added to other configurations.

A part or the entirety of each of the above configurations, functions, processing units, processing means, and the like may be realized by hardware, such as by designing integrated circuits therefor. In addition, the present invention can be realized by program codes of software that realizes the functions of the embodiment. In this case, a storage medium on which the program codes are recorded is provided to a computer, and a CPU that the computer is provided with reads the program codes stored on the storage medium. In this case, the program codes read from the storage medium realize the functions of the above embodiment, and the program codes and the storage medium storing the program codes constitute the present invention. Examples of such a storage medium used for supplying program codes include a flexible disk, a CD-ROM, a DVD-ROM, a hard disk, a solid state drive (SSD), an optical disc, a magneto-optical disc, a CD-R, a magnetic tape, a non-volatile memory card, and a ROM.

The program codes that realize the functions written in the present embodiment can be implemented by a wide range of programming and scripting languages such as assembler, C/C++, Perl, shell scripts, PHP, Python and Java.

It may also be possible that the program codes of the software that realizes the functions of the embodiment are stored on storing means such as a hard disk or a memory of the computer or on a storage medium such as a CD-RW or a CD-R by distributing the program codes through a network and that the CPU that the computer is provided with reads and executes the program codes stored on the storing means or on the storage medium.

In the above embodiment, only control lines and information lines that are considered as necessary for description are illustrated, and all the control lines and information lines of a product are not necessarily illustrated. All of the configurations of the embodiment may be connected to each other.

What is claimed is:

1. A computer comprising an arithmetic device and a storage device coupled the arithmetic device and generating a model for outputting an output value on the basis of a plurality of pieces of time-series data having different data types,
the model including a network that is formed of connections of a plurality of nodes having a recursive structure and updates states of the plurality of nodes according to a predetermined time step, and an adder that calculates the output value by adding values obtained by multiplying each of a plurality of values output from the network by a plurality of weights, and
the computer further comprising:
a learning unit configured to execute, for each of a plurality of output values, a learning process of calculating weight data deter mining the model and including the plurality of weights by using learning data composed of teacher data and a plurality of pieces of time-series data having different data types; and
a first storing unit configured to store a plurality of learning results each of which correlates a type of the output value and the weight data with each other.

2. The computer according to claim 1, further comprising:
a second storing unit configured to store the weight data; and
a third storing unit configured to store a sampling interval for sampling time-series data to be input to the model from the plurality of pieces of time-series data,
wherein the learning unit includes:
an input data processing unit configured to generate a plurality of pieces of learning time-series data by sampling the plurality of pieces of time-series data included in the learning data on the basis of the sampling interval stored in the third storing unit and input the plurality of pieces of learning time-series data to the model; and
a comparator configured to compare the output value output from the model and the teacher data, and update the plurality of weights included in the weight data and the sampling interval on the basis of a comparison result, and
wherein the learning unit is configured to store a learning result to the first storing unit, the learning result correlates the type of the output value, the weight data stored in the second storing unit, and the sampling interval stored in the third storing unit with each other.

3. The computer according to claim 2, wherein the model includes control of inputting the plurality of pieces of time-series data to the network with a delay corresponding to the sampling interval.

4. The computer according to claim 2, further comprising a fourth storing unit configured to store the learning data,
wherein the input data processing unit is configured to generate the plurality of pieces of learning time-series data by sampling the plurality of pieces of time-series data included in the learning data from the fourth storing unit so as to be synchronized with the time step.

5. The computer according to claim 2,
wherein the model includes a plurality of adders,
wherein the learning unit includes a plurality of comparators so as to form a pair with each of the plurality of adders,
wherein the computer comprises a plurality of third storing units so as to form a pair with each of the plurality of comparators, and
wherein the learning unit is configured to execute a plurality of learning processes related to the plurality of output values in parallel using a set composed of one of the plurality of adders, one of the plurality of comparators, and one of the plurality of third storing units.

6. The computer according to claim 1, wherein the network is an Echo State Network.

7. The computer according to claim 1, further comprising a predictor configured to obtain the learning result from the first storing unit to construct the model and outputs the output value corresponding to the learning result by inputting analysis time-series data to the model.

8. A data processing method executed by a computer, for generating a model for outputting an output value on the basis of a plurality of pieces of time-series data having different data types,
the computer including an arithmetic device and a storage device coupled to the arithmetic device,
the model including a network that is formed of connections of a plurality of nodes having a recursive structure and updates states of the plurality of nodes according to a predetermined time step, and an adder that calculates the output value by adding values obtained by multiplying each of a plurality of values output from the network by a plurality of weights, and
the data processing method including:
a first step of executing, by the arithmetic device, for each of a plurality of output values, a learning process of calculating weight data determining the model and including the plurality of weights by using learning data composed of teacher data and a plurality of pieces of time-series data having different data types; and
a second step of storing, by the arithmetic device, a plurality of learning results each of which correlates a type of the output value and the weight data with each other in the storage device.

9. The data processing method according to claim 8,
wherein the computer includes a first storing unit configured to store the piece of weight data, and a second storing unit configured to store a sampling interval for sampling time-series data to be input to the model from the plurality of pieces of time-series data,
wherein the first step includes:
a third step of generating, by the arithmetic device, a plurality of pieces of learning time-series data by sampling the plurality of pieces of time-series data included in the learning data on the basis of the sampling interval stored in the second storing unit;
a fourth step of inputting, by the arithmetic device, the plurality of pieces of learning time-series data to the model;
a fifth step of comparing, by the arithmetic device, the output value output from the model and the teacher data;
a sixth step of updating, by the arithmetic device, the plurality of weights included in the weight data and the sampling interval on the basis of a comparison result; and
a seventh step of storing, by the arithmetic device, the updated weight data in the first storing unit and the updated sampling interval in the second storing unit, and
wherein the second step includes a step of storing, by the arithmetic device, the learning result that correlates the type of the output value, the weight data stored in the first storing unit, and the sampling interval stored in the second storing unit with each other in the storage device.

10. The data processing method according to claim 8, wherein the model includes control of inputting the plurality of pieces of time-series data to the network with a delay corresponding to the sampling interval.

11. The data processing method according to claim 9,
wherein the computer includes a third storing unit configured to store the learning data, and
wherein the third step includes a step of generating, by the arithmetic device, the plurality of pieces of learning time-series data by sampling the plurality of pieces of time-series data included in the learning data from the third storing unit so as to be synchronized with the time step.

12. The data processing method according to claim 9, wherein the first step includes a step of executing, by the arithmetic device, a plurality of learning processes related to the plurality of output values in parallel.

13. The data processing method according to claim 8, wherein the network is an Echo State Network.

14. The data processing method according to claim 8, further including:
a step of obtaining, by the arithmetic device, the learning result from the storing device to construct the model; and
a step of outputting, by the arithmetic device, the output value corresponding to the learning result by inputting analysis time-series data to the model.
